(19) United States
(12) Patent Application Publication
(10) Pub. No.: US 2009/0067605 A1
(43) Pub. Date: Mar. 12, 2009

(54) Video Sequence for a Musical Alert

(76) Inventors: Jukka A. Holm, Tampere (FI); Kai Havukainen, Lempaala (FI); Antti Eronen, Tampere (FI)

Correspondence Address: HARRINGTON & SMITH, PC, 4 RESEARCH DRIVE, Suite 202, SHELTON, CT, 06484-6212, US

(21) Appl. No.: 12/224,203

(22) PCT Filed: Feb. 21, 2006
(86) PCT No.: PCT/IB2006/001033

§ 371 Date: Aug. 19, 2008

(51) Int. Cl. H04M 3/42

(52) U.S. Cl. 379/207.16

(57) ABSTRACT

A method of creating a video sequence for display in synchronization with a musical alert including selecting one or more images; modifying the one or more selected images in dependence upon musical metadata for the musical alert to create a video sequence, wherein the extent and/or type of modification is dependent upon the musical metadata; and playing the video sequence with the musical alert.

### FIELD OF THE INVENTION

Embodiments of the present invention relate to the creation and display of a video sequence for a musical alert. In particular, they relate to a method of creating a video sequence for display in synchronization with a musical alert and an electronic device for displaying a video sequence in synchronization with a musical alert.

### BACKGROUND TO THE INVENTION

Current music player software has visualizations that change according to the music that the user listens to. However, the visualizations are abstract and impersonal.

It would be desirable to provide for the visualization of a musical alert. In particular, the visualization of a ring tone of a telephone.

### DEFINITIONS

‘modification’ of an image means a significant change in the appearance of at least a portion of the image that is presented to a user. It does not include resealing or cropping.

### BRIEF DESCRIPTION OF THE INVENTION

According to one embodiment of the invention there is provided a method of creating a video sequence for display in synchronization with a musical alert comprising: selecting one or more images; modifying the one or more selected images in dependence upon musical metadata for the musical alert to create a video sequence, wherein the extent and/or type of modification is dependent upon the musical metadata; and playing the video sequence with the musical alert.

According to another embodiment of the invention there is provided an electronic device for displaying a video sequence in synchronization with a musical alert comprising: means for analyzing the musical alert to obtain musical metadata; means for selecting one or more images; means for modifying the one or more selected images in dependence upon the musical metadata to create a video sequence, wherein the extent and/or type of modification is dependent upon the musical metadata; and means for playing the video sequence with the musical alert.

The musical metadata dependent modification provides the advantage that the video may change in rhythm with the music and/or the video may have a ‘mood’ associated with the music.

The selection of the image(s) enables the creation of a personalized video.

The one or more images may be selected from a personalized population of images. This provides a personalized visualization of the musical alert.

The personalized population of images may include images captured by the user and images selected by the user for a purpose or purposes other than video sequence creation.

The selection of an image or images may be dependent upon the musical metadata. If the device is a telephone, and the musical alert is a ring tone, the selection of an image or images may be dependent upon the identity of a telephone caller.

According to a further embodiment of the invention there is provided a method of creating a video sequence for display in synchronization with a audio alert comprising: selecting one or more images; modifying the one or more selected images in dependence upon audio metadata for the audio alert to create a video sequence, wherein the extent and/or type of modification is dependent upon the audio metadata; and playing the video sequence with the audio alert.

### BRIEF DESCRIPTION OF THE DRAWINGS

For a better understanding of the present invention reference will now be made by way of example only to the accompanying drawings in which:

FIG. 1A schematically illustrates an electronic device that produces musical alerts and

FIG. 1B schematically illustrates the operation of the device;

FIG. 2A is an illustrative example of a method for analyzing a musical alert (ring tone);

FIG. 2B schematically illustrates an entry in a contacts database;

FIG. 2C illustrates a method 70 of video creation;

FIGS. 3A-3D illustrate modifications to images; and

FIG. 4 illustrates a method for controlling the playing of a video with a musical alert.

### DETAILED DESCRIPTION OF EMBODIMENTS OF THE INVENTION

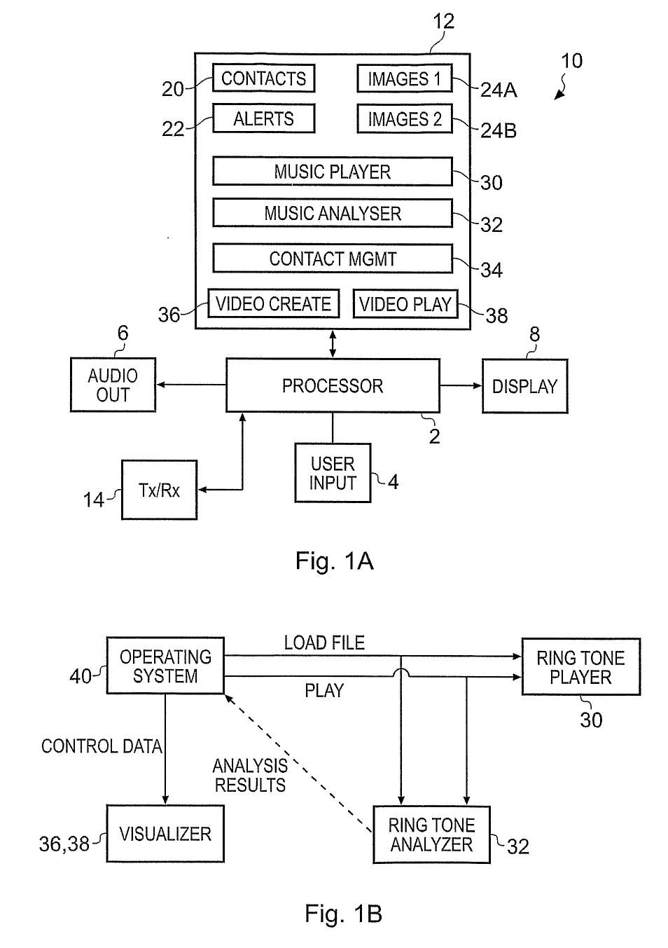

FIG. 1A schematically illustrates an electronic device 10 that produces musical alerts. The particular electronic device 10 illustrated is a mobile cellular telephone, but this is one example of many different types of suitable electronic devices.

The mobile cellular telephone 10 comprises a processor 2, a memory 12, a display 8, a user input mechanism 4 such as, for example a keypad, joystick, touch-screen etc., an audio output mechanism 6 such as a loudspeaker, headphone jack etc and a cellular radio transceiver 14 for communicating in a cellular telephone network. Only the components necessary for the following description have been illustrated. The mobile cellular telephone may have additional components.

The processor 2 is arranged to write to and read from the memory 12. It is connected to receive user input commands from the user input mechanism 4 and to provide output commands to the audio output device 6 and, separately, to the display 8. The processor 2 is connected to receive data from the cellular radio transceiver 14 and to provide data to the cellular transceiver 14 for transmission.

The memory 12, in this example, stores a contacts database 20, musical alerts (ring tones) 22, images 24A at a first memory location, images 24B at a second memory location, a music player software component 30, a music analyzer software component 32, a contact management software component 34, a video creation software component 36 and a video playback software component 38.

Although the memory is illustrated as a single entity in the figure it may be a number of separate memories some of which may be removable such as SD memory cards or similar.

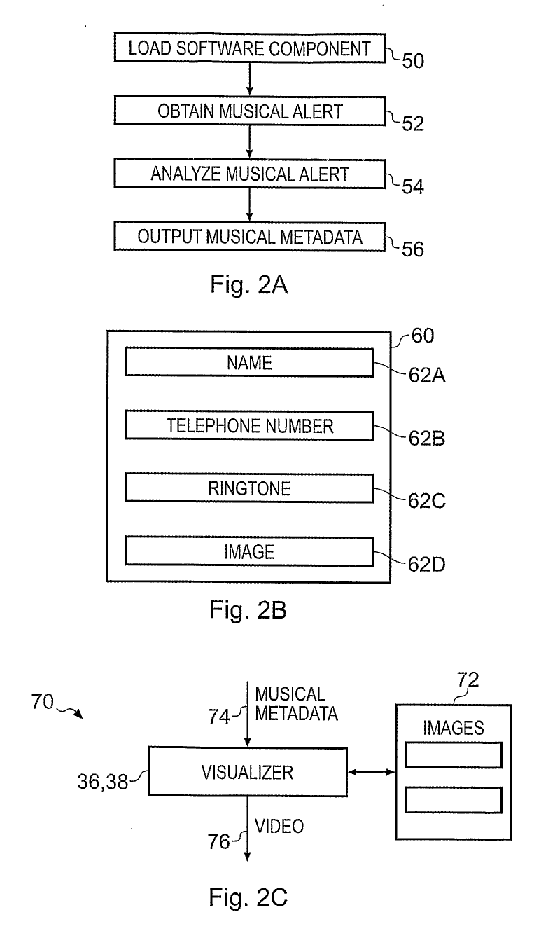

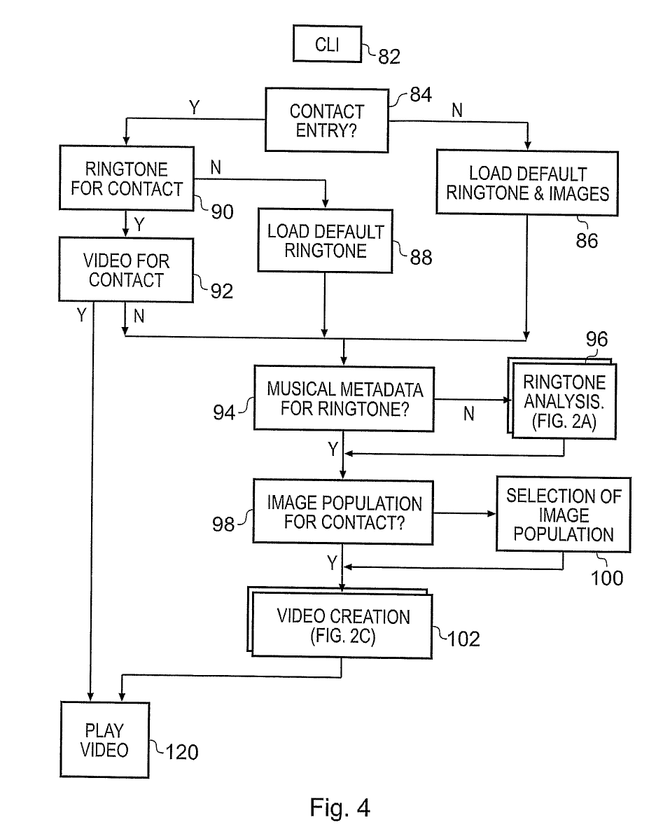

The software components control the operation of the electronic device 10 when loaded into the processor. The software components provide the logic and routines that enable the electronic device 10 to perform the methods illustrated in FIGS. 2A, 2C and 4.

The software components may arrive at the electronic device 10 via an electromagnetic carrier signal or be copied from a physical entity such as a computer program product, a memory device or a record medium such as a CD-ROM or DVD.

FIG. 1B schematically illustrates the operation of the device 10 as a system of functional 1 blocks including an operating system block 40, a ring tone player block (provided by the music player software component 30), a ring tone analyzer block (provided by the music analyzer software component 32), and a visualizer block (provided by the video creation software component 36 and the video playback software component 38).

The operating system block 40 refers to those parts of mobile phone's operating system that take care of communications with the cellular radio transceiver 14, accessing the contacts database 20, musical alerts 22 etc and control of the display 8.

When an incoming call arrives, the operating system block 40 loads a ring tone 22 to both the ring tone player block 30 and the ring tone analyzer block 32.

The music player component 30 may be any music player such as a MIDI synthesizer, MP3 or AAC player, etc. It controls the sounds that are output by the audio output device 6.

The music analyzer component 32 is used to analyze the ring tone for relevant musical features such as pitch, energy, tempo, and occurrence of certain instruments. The list of features is dependent on the used audio format.

The ring tone analyzer block and the ring tone player block are independent of each other. If the device 10 has enough processing power, the analysis can be done in realtime. If the device 10 is too slow, the analysis can be started a little bit earlier or can be done in advance. In the case of advance analysis, the analysis results are stored as metadata in association with the audio file 22 for the ring tone.

The visualizer block controls the selection, modification and transition of images used for visualization. Selection and modification depend on music metadata received from the operating system but produced by the ring tone analyzer block.

FIG. 2A is an illustrative example of a method for analyzing a musical alert (ring tone). The music analyzer software component 32 is loaded into the processor 2 at step 50. The processor 2 then reads a musical alert data structure 22, such as an MP3 file, from the memory 12 in step 52. At step 54, the music analyzer software analyzes the music of the musical alert (ring tone) 22 and, at step 56, produces as output musical metadata that records attributes of the music such as tempo, pitch, energy.

The musical metadata may record these attributes for each of a plurality of instruments used in the musical alert and it may record how they vary with time, if at all.

From the analysis point of view, musical alert (ring tone) formats can be divided into two major categories: synthetic (i.e. symbolic) audio like MIDI and digital (i.e. non-symbolic) audio like MP3, AAC, Wave, etc.

The MIDI symbolic audio format, has sixteen different channels, and each channel can refer to one instrument at a time. It is therefore possible to obtain detailed information about any musical parameter of the song.

The music analyzer component 32 can detect any MIDI event, for example, it can detect when any of the following situations occurs:
Song's tempo is set or changed;
A certain number of notes is played simultaneously;
A certain pitch (i.e. C3) is played;
A certain instrument is selected or played.

Any MIDI event can be sent to the operating system block of the system as music metadata and thus be used to control the visualizer block.

If MP3 ID3 meta-data is available, the musical genre can also be extracted and produced as music metadata for use by the visualizer.

MP3, AAC, etc. are not symbolic audio formats and the analysis method for these audio formats are different from those of symbolic audio and are more processor resource intensive. It may not be possible to perform this analysis in real time.

Some features are easy to extract from symbolic audio, and difficult to extract from sampled audio. In case of compressed sampled audio such as MP3 or AAC, the analyzer may decode the audio to PCM format such that the same set of analysis methods can be applied to different audio compression formats. Another alternative is to do the audio analysis in a compressed domain, for example beat detection methods exist (Wang, Vilermo, “System and method for compressed domain beat detection in audio bitstreams”, US Pat. App. 2002/0178012 A1).

The detection of pitches from the signal is a complicated problem. Monophonic pitch detection algorithms exist. An example of monophonic pitch detection algorithm for sampled audio is: A. de Cheveigne and H. Kawahara, “YIN, a fundamental frequency estimator for speech and music,” J. Acoust. Soc. Am., vol. 111, pp. 1917-1930, April 2002. An example of polyphonic pitch detection: Matti P. Ryynänen and Anssi Klapuri: “POLYPHONIC MUSIC TRANSCRIPTION USING NOTE EVENT MODELING”, Proc. IEEE Workshop on Applications of Signal Processing to Audio and Acoustics, Oct. 16-19, 2005, New Paltz, N.Y. Although it is impossible to get all the pitches estimated from a polyphonic music excerpt, this kind of methods can be used to analyze the dominant melody. Although the estimate for the dominant melody may be noisy and erroneous as the transient sounds (drums) make the estimation difficult, this may not be a problem if the estimate is used to control visual effects since the result may look good even though the estimate is not absolutely correct. The system could also apply e.g. low pass filtering to the pitch estimates to make them change less often if the pitch estimator produces spurious and noisy pitch estimates.

The pitches and pitch changes may be detected and produced as musical metadata for use by the visualizer block.

The tempo of digital audio can be calculated using a beat tracking algorithm such as the one presented in Seppänen, J., Computational models of musical meter recognition, M.Sc. thesis, TUT 2001. The tempo may be produced as musical metadata for use by the visualizer block.

A filter bank may be used to divide the music spectrum into N bands, and analyze the energy in each band. As an example, the energies and energy changes in different bands can be detected and produced as musical metadata for use by the visualizer block.

The musical metadata may identify different instruments. Essid, Richard, David, “Instrument Recognition in polyphonic music”, In Proc. IEEE Int. Conference on Acoustics, Speech, and Signal Processing 2005, provides a method for recognizing the presence of different musical instruments.

The musical metadata may identify music harmony and tonality: Gomez, Herrera: “Automatic Extraction of Tonal Metadata from Polyphonic Audio Recordings”, AES 25th International Conference, London, United Kingdom, 2004 Jun. 17-19, provides a method for identifying music harmony and tonality.

The musical metadata may identify the music genre. There exists methods to classify the music genre automatically from sampled music, e.g.: “Musical Genre Classification of Audio Signals” George Tzanetakis and Perry Cook IEEE Transactions on Speech and Audio Processing, 10(5), July 2002

The musical metadata may identify the music key. An example of key finding from sampled audio is Özgur Izmirli: “An Algorithm for audio key finding”, ISMIR 2005 (6th International Conference on Music Information Retrieval London, UK, 11-15 Sep. 2005).

Other musical metadata could include music mood (happy/neutral/sad), emotion (soft/neutral/aggressive), complexity, and vocal content (vocals vs. instrumental), tempo category (slow, fast, very fast, varying). Methods and features to extract this kind of metadata were evaluated e.g. in Tim Pohle, Elias Pampalk and Gerhard Widmer: “EVALUATION OF FREQUENTLY USED AUDIO FEATURES FOR CLASSIFICATION MUSIC INTO PERCEPTUAL CATEGORIES”, Proceedings of the Fourth International Workshop on Content-Based Multimedia Indexing (CBMI'05), Riga, Latvia, June 21-23.

FIG. 2B schematically illustrates an entry 60 in a contacts database 20. The contacts database has a plurality of entries. Typically an entry is for a single contact such as a friend or member of one's family. An entry comprises a plurality of items 62 that provide contact, and possibly other, information about the contact. The items typically include, for example, a name 62A, a contact telephone number 62B, a contact address etc. A contact entry may be stored as a data structure that contains or references other data structures that provide the contact items.

A ‘ring tone’ item 62C within a contact entry may allow a user to specify a particular musical alert to be used to alert the user when this contact telephones the user. The item may, for example, reference a musical alert file 22.

In telephone networks, it is common practice when an originating terminal calls a destination terminal for the telephone number of the originating terminal to be sent to the destination terminal. The user of the destination terminal may therefore be presented with the originating terminal's telephone number as an alert for the incoming call is generated. This feature is often referred to as ‘call line identification’ (CLI). The association within a contact entry 60 between a telephone number 62B and a musical alert 62C, allows the destination terminal to use the identified originating terminal's telephone number, received via CLI, to access and play the musical alert 62C associated with that telephone number 62B within a contact entry 60.

According to an embodiment of the invention, there is also provided within a contact entry, an image item or image items 62D for specifying one or more images. The images specified may be video clips and/or pictures and/or graphic files. The association within a contact entry between a telephone number and one or more specified images, allows the destination terminal to use the originating terminal's telephone number, received via CLI, to access the images specified in entry 62D for the contact entry that also includes the originating terminal's telephone number 62B.

FIG. 2C illustrates a method 70 of video creation. The visualizer block 36, 38 is operable to select, modify and transition an image or images in dependence upon the musical metadata 74 produced by the ring tone analyzer block 32. The visualizer block creates as output a video 76 that may be played on the display 8 and/or stored in the memory 12. The output video may, for example, be stored as an image item 62D of a contact entry 60. The video would consequently be played along with the ring tone whenever that contact telephoned the user.

The image or images rendered in the video 76 are selected from a population of images. The population of images is a personalized collection of images comprising images that the user has captured or selected for personal use such as a background image in an idle screen. The images may be located at various memory locations such as in a gallery of captured images or as image items 62D of contact entries. An image may be, for example, a picture or a frame from a video clip.

The user may also selected which images in the image collection can be used as the personalized population. The population of images may also depend upon the musical metadata received from the music analyzer and/or on other contextual information, such as the identity of a telephone caller.

The musical metadata 74 may affect the selection of an image or images from the population of images.

For example, if the music metadata indicates that the musical alert is of a heavy metal genre, the visualizer block selects an image or images from the population of images that are more dark-colored. Whereas, if the music metadata indicates that the musical alert is of a more light-hearted genre, such as dinner time jazz, the visualizer block selects an image or images from the population of images that are more light-colored and/or more colorful.

Instead of color or brightness, genre could also be mapped to other visual features such as complexity of images (lots of/few regions, lines etc.).

If multiple images are selected, the visualizer may order the images. For example, if the ring tone begins slowly and peacefully but grows so that it is very intense in the end, the images may be selected so that bright images are shown first and dark ones in the end.

The selected image or images may be processed to modify it/them. The modification is based on the musical metadata 74 received from the music analyzer. For example modifications may occur as a result of a value or a change in any one or more of pitch, energy, tempo (as a whole or in relation to certain instruments).

The musical metadata 74 may define the amount and/or the type of the modification. ‘Modification’ of an image means a significant change in the appearance of at least a portion of the image that is presented to a user. It does not include resealing or cropping.

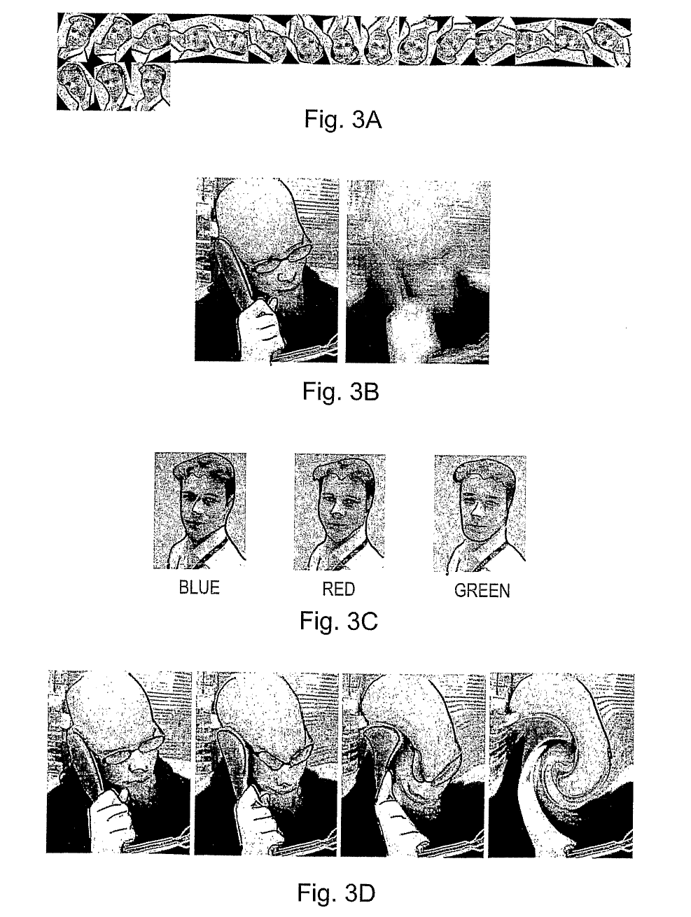

As an example, in the case of an incoming call, the image of calling person could be shown on the display 8 and rotate to the tempo of ring tone music. The image is rotated in sync with the beat as illustrated in FIG. 3A.

As another example, in the case of an incoming call, the image of calling person could be shaken or rippled. A beat or an energy value above a predetermined threshold in the low frequency bands can also be used to shake the image in the similar way that water ripples in a glass when placed on top of a loudspeaker. This is illustrated in FIG. 3B.

As another example, in the case of an incoming call, the image of calling person could be colored in dependence on the musical metadata 74. The audio signal energies from different frequency bands are analyzed in the music analyzer block and the resulting musical metadata 74 is used by the visualizer block to emphasize certain color elements of an image. For example, the energy of low frequencies (up to e.g. 400 Hz) adjusts the amount of blue color saturation of the image, middle frequencies (e.g. from 400 Hz to 3000 Hz) adjusts the red color saturation, and high frequencies (3000 Hz and above) the green color saturation. This can make the image flash colorfully with the rhythm of musical alert and in general change its colors whenever the frequency content of the music changes.

As another example, in the case of an incoming call, the image of calling person could be colored in dependence upon the musical genre. Information about genre and tempo can be extracted by the musical analyzer block and used by the visualizer block. Slower and more ambient genres may result in a brighter image having light colors, while fast and heavy music may result in darker colors. The mapping could be e.g. the following:
Heavy, aggressive, fast, etc. music->Black, dark images
Slow, relaxed, ambient, classical, etc. music->White, yellow, light, bright
Blues->Blue
Country->Green
Funk, soul->Brown
Glam rock->Pink
Etc.

As another example, in the case of an incoming call, the image of calling person could be whirled in dependence upon the musical metadata 74. Energy values of the audio signal (of a certain frequency range) identified in the music metadata can be used to whirl the image. The more energy the heavier the applied whirl as illustrated in FIG. 4D.

The above described example modifications have been applied to the whole of an image. However, a modification may only be applied, in some embodiments, to a portion of an image. For example, an image could be filtered to identify portions of the image that have a predetermined characteristic (e.g. color) and those identified portions could be modified. The user may be able to define the predetermined characteristic or, alternatively, identify portions for modification.

The various images may be transition by a direct cut or using other techniques such as cross-fade transition that can be synchronized to the music, morphing and image explosion.

FIG. 4 illustrates a method 80 for controlling the playing of a video with a musical alert

At step 82, an incoming caller's telephone number is extracted using CLI.

Next at step 84, the contact database 20 is searched for a contact entry 60 containing a telephone number item 62B corresponding to the identified telephone number. If such a contact entry exists, the process moves to step 90. If such a contact entry does not exist, the process moves to step 86.

At step 86, a default musical alert is loaded and a default population of images is loaded. The process then moves to step 94.

At step 90, the found contact entry is searched to identify an associated musical alert. If a musical alert is found the process moves to step 92, otherwise a default musical alert is loaded at step 88 and the process continues to step 94.

At step 92, the found contact entry is searched to identify an associated video 76. If such a video is found, the process moves to step 120 where the video is played otherwise the process moves to step 94.

At step 94, the musical alert is checked to confirm whether or not it already has musical metadata 74 associated with it. If it does have musical metadata 74 associated with it, the process moves to step 98. If it does not have musical metadata 74 associated with it, the process moves to step 96 where the musical alert is analyzed by the ring tone analysis block as previously described in relation to FIG. 2A. The resultant musical metadata is stored in association with the musical alert.

At step 98, the process checks whether or not an image population exists for this contact. If a population does exists, the process moves to step 102 and if a population does not exists the process moves to step 100.

At step 100, a population of images is generated. The population is preferably based upon personal images i.e. those captured or selected by the user. The population may also be based upon the identity of the caller and/or the musical metadata 74. After generating a population of images, the process moves to step 102.

At step 102, a video is created using the population of images by the visualizer block as previously described in relation to FIG. 2C. The extent and type of modification applied to an image or images may be dependent upon the musical metadata and/or the identity of the caller.

The produced video 76 is then played at step 120 in the display 8. The video may also, at the option of the user, be stored in the contact entry 60 (if any) for the caller for future use.

Although embodiments of the present invention have been described in the preceding paragraphs with reference to various examples, it should be appreciated that modifications to the examples given can be made without departing from the scope of the invention as claimed.

For example, although the above embodiment describes the analysis of the musical alert to obtain the metadata as occurring at the electronic device, in other embodiments the musical metadata may be created by a third party and transferred to the electronic device. In this case, the electronic device need not be capable of analyzing a musical alert. Some example situations are the musical alert is analyzed on a PC and not on a mobile device but is transferred along with the file for the musical alert to the mobile device; the musical alert is analyzed on the servers of a music service, then attached to a file for the musical alert and the combination is downloaded to the electronic device; the user of the electronic device downloads musical metadata for an existing musical alert by sending identifying information to a server, which then finds the proper metadata for the song of the musical alert.

The musical metadata in the example given has been automatically produced by computer analysis. However, the metadata delivered from the music service or ring tone seller may be annotated by human experts instead of being produced by automatic analysis. Also, a user of the electronic device may be able to annotate the musical metadata themselves by, for example, adding genre labels or mood information to the musical alert files stored on the electronic device.

Although embodiments of the invention have been described with reference to a musical alert, the alert need not by musical but may be any form of human audible alert, such as a sound effect e.g. an animal noise, machine noise etc. When audio alerts are used, a pre-analysis stage may be introduced in which the type of audio alert is first identified e.g. musical, speech, animal noise etc and then an analysis method optimized for that type is used so that the metadata produced depends upon the audio alert type. Non-musical audio samples can be analyzed for audio metadata, such as the frequency content using the filter bank energies or mel-frequency cepstral coefficients as known from the speech recognition domain, or the MPEG-7 low-level audio descriptors. For example, if a dog bark noise was measured for energy, the energy could be used to control the ripple effect in images. A high frequency bird tweet may select bright images, a low frequency growl of a bear or an engine sound may select darker images. If the pitch of the sample was used to control the color saturation then images shown during a high frequency bird tweet will look different than a cat meow or a bear growl. If the ring tone was a speech sample, then mapping the energy or spectral content of speech to image effects could make the images e.g. ripple to the pace of the uttered speech.

Although the musical alert has been primarily described in the application of a ring tone for a telephone, it should be understood that it could also be an appointment alert in a Calendar application, an alarm clock alert etc. The images selected for the alert may in these circumstances also depend upon the nature of the appointment etc.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method of creating a video sequence for display in synchronization with a musical alert comprising:
selecting one or more images;
modifying the one or more selected images in dependence upon musical metadata for the musical alert to create a video sequence, wherein the extent and/or type of modification is dependent upon the musical metadata; and
playing the video sequence with the musical alert.

2. A method as claimed in claim 1, wherein the extent of modification is dependent upon the musical metadata.

3. A method as claimed in claim 1, wherein the type of modification is dependent upon the musical metadata.

4. A method as claimed in claim 1 wherein the one or more images are selected from a personalized population of images.

5. A method as claimed in claim 4, wherein the personalized population of images includes images captured by the user and images selected by the user for a purpose or purposes other than video sequence creation.

6. A method as claimed in claim 4, wherein the images within the personalized population are used for different purposes other than video creation.

7. A method as claimed in claim 1, wherein the selection is dependent upon the musical metadata.

8. A method as claimed in claim 1, wherein the musical alert is a ring tone for a telephone.

9. A method as claimed in claim 8, wherein the ring tone is dependent upon the identity of a telephone caller.

10. A method as claimed in claim 9, wherein the selection of image(s) is dependent upon the identity of a telephone caller.

11. A method as claimed in claim 9, wherein the extent of modification is dependent upon the identity of a telephone caller.

12. A method as claimed in claim 9, wherein the type of modification is dependent upon the identity of a telephone caller.

13. A method as claimed in claim 1, wherein the musical metadata identifies one or more of tempo, pitch, energy.

14. A method as claimed in claim 1, further comprising analyzing the musical alert to obtain musical metadata.

15. A computer program for performing the method of claim 1.

16. A physical entity embodying the computer program as claimed in claim 15.

17. An electronic device for displaying a video sequence in synchronization with a musical alert comprising:
means for selecting one or more images;
means for modifying the one or more selected images in dependence upon musical metadata for the musical alert to create a video sequence, wherein the extent and/or type of modification is dependent upon the musical metadata; and
means for playing the video sequence with the musical alert.

18. An electronic device as claimed in claim 17, comprising one or more memories for storing personalized population of images, wherein the one or more images are selected from the personalized population of images.

19. An electronic device as claimed in claim 18, wherein the personalized population of images includes images captured by the user and images selected by the user for a purpose or purposes other than the video sequence.

20. An electronic device as claimed in claim 17, operable as a telephone, wherein the musical alert is a ring tone for the telephone

21. An electronic device as claimed in claim 17 further comprising means for analyzing the musical alert to obtain musical metadata.

22. A method of creating a video sequence for display in synchronization with an audio alert comprising:
selecting one or more images;
modifying the one or more selected images in dependence upon audio metadata for the audio alert to create a video sequence, wherein the extent and/or type of modification is dependent upon the audio metadata; and
playing the video sequence with the audio alert.
